(19) United States
(12) Patent Application Publication
(10) Pub. No.: US 2005/0224152 A1
(43) Pub. Date: Oct. 13, 2005

(54) Tire traction enhancing device

(76) Inventor: Fredrick Zumach, Orangeville (CA)

Correspondence Address: ROBERT W. J. USHER;PATENT AGENT, 1133 BROADWAY, #1515, NEW YORK, NY, 10010, US

(21) Appl. No.: 11/101,187

(22) Filed: Apr. 7, 2005

(30) Foreign Application Priority Data
Apr. 8, 2004 (CA) 2464018

(51) Int. Cl. B60C 11/00

(52) U.S. Cl. 152/222

(57) ABSTRACT

A tire traction enhancing device has a flexible rectangular body member with a plurality of protrusions extending outwardly and inwardly therefrom and a bungee type cord attached to each end. Assembly is by placing the body member on the tire tread surface, pulling the bungee type cord around the inner side of the tire such that the bungee type cord rests on the axle, and hooking the bungee type cord to itself at the outer tire sidewall. The inward protrusions project into the spaces in the tire tread and are sized to be passively held therein further securing the device on the tire. The outward protrusions add traction to the tire tread during rotation, and may form a standard tractor tread pattern, maximizing traction. The device is lightweight, portable, safe, compact, durable, easy to install and remove by one person without any additional tools or mechanical knowledge.

### RELATED APPLICATION

Priority is claimed from Canadian patent application 2464018 filed Apr. 8, 2004, the disclosure of which is incorporated herein by reference.

### FIELD OF THE INVENTION

The present invention relates to a portable device that is attachable to a vehicle tire for enhancing the traction in order to assist the vehicle to escape from being stuck in mud or snow.

### BACKGROUND OF THE INVENTION

The tires of cars and other vehicles often get stuck in deep mud or snow. The driver typically relies on “rocking” the vehicle backwards and forwards by accelerating and reversing to try to escape from being stuck. If that does not work, one may need the assistance of people or a tow truck to push or pull the vehicle out, neither of which may be readily available.

Alternatively, one can try to create an artificial surface for the tires to travel along, for example, putting sand or ash, or wood or cardboard on top of the snow or mud in the tires' path. Often this approach is messy or doesn't work, or one does not have access to such materials at the time one's vehicle becomes stuck.

There are known traction devices, typically in the form of flat plates that may be inserted between the tire and the mud or snow or other ground material to provide an artificial surface for the tire to grip. The problem with these devices is that they may sink into the snow or mud with the weight of the vehicle, and they require careful attention to positioning, which often results in the installer becoming covered with snow or mud in the process. Additionally, such plate type devices are generally not of sufficient length to ensure that the vehicle will have traversed to stable ground after traversing the plate, and it would be impractical to carry enough plates to ensure that sufficient cumulative length could be available. Also, if the tires are accelerated to sufficient velocity to get the required momentum to free the vehicle, the plate can be pushed rapidly away from the vehicle following the tire's traverse, “shooting out” and potentially injuring a bystander and increasing the risk of the device becoming damaged or lost. The plate devices are also easily susceptible to being broken.

Other known devices include snow chains, but these are generally time consuming and cumbersome to install, and would generally be installed in advance of a vehicle becoming stuck, rather than once a vehicle has become stuck. Such chains damage road surfaces and do not prevent side-to-side slipping of the vehicle.

Other more modern versions of snow chains include portable devices, which wrap around a vehicle tire. These devices tend to be complicated, labour intensive, time consuming and dirty to install, often requiring additional tools, mechanical ability or modification to the vehicle tire in order to operate.

What is desired therefore is a novel apparatus that overcomes the limitations and problems associated with earlier devices.

Preferably, such a device would be portable, durable, compact, flexible, and lightweight. It would be easy to install and remove by one person without any additional tools or mechanical knowledge, and it would be safe and clean to operate. Such a device would preferably attach to a vehicle tire to form a semi-continuous area of extra traction when the tire rotates. It would provide sufficient lateral resistance in order to minimise side slippage of the vehicle. It would not damage the tires or roads.

The present invention provides such a solution to overcoming the foregoing difficulties.

### BRIEF DESCRIPTION OF THE DRAWINGS

Embodiments of the invention will now be described, by way of example only, with reference to the accompanying drawings, wherein:

FIG. 1 is a top view of a preferred embodiment of the device, namely a tire traction enhancing device, according to a preferred embodiment of the present invention;

FIG. 2 is a side view of a portion of the device;

FIG. 3 is a close up side view of a portion of the device;

FIG. 4 is a close-up top view of a portion of a preferred embodiment of the device;

FIG. 5 is a side view of a preferred embodiment of the device in operation around the outer surface of a tire; and

FIG. 6 is a side view of a preferred embodiment of the device in operation around the inner surface of a tire.

### DESCRIPTION OF PREFERRED EMBODIMENT

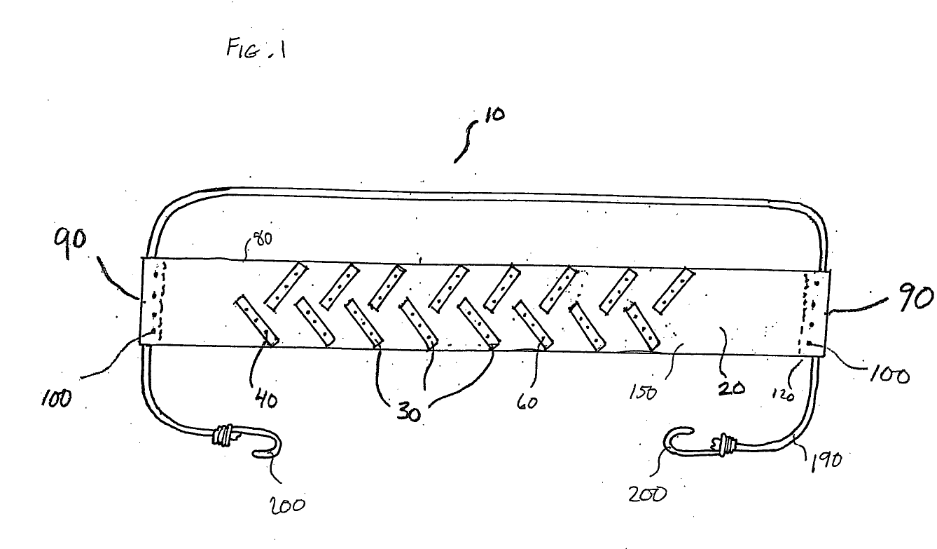

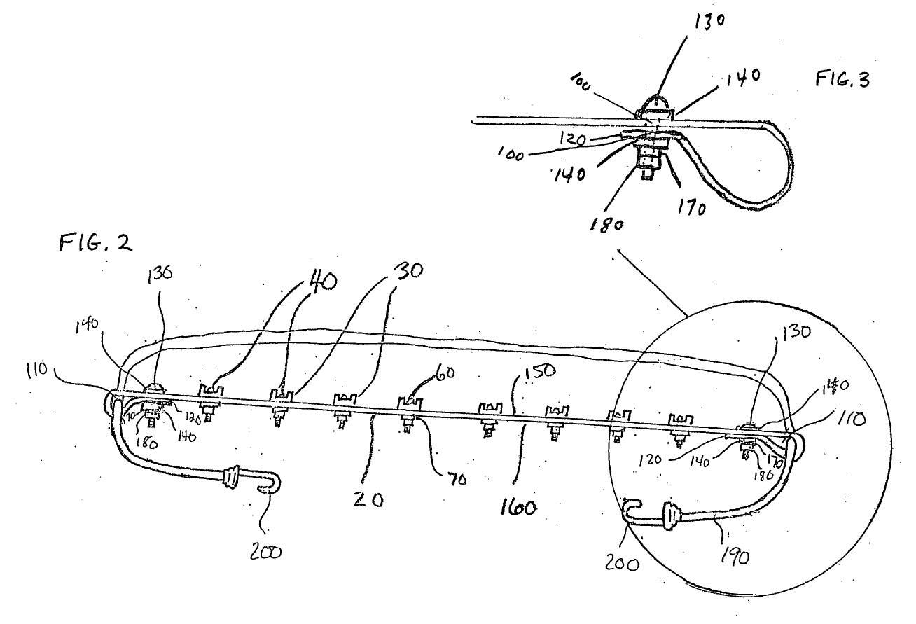

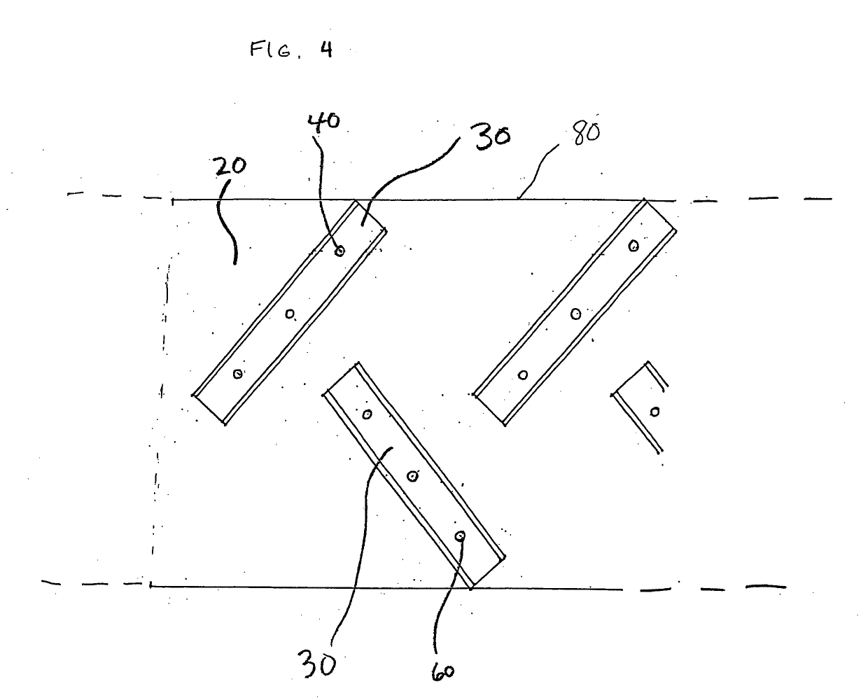

FIGS. 1, 2, 3, 4, and 5 show a preferred embodiment of a tire traction enhancing device, indicated generally by reference numeral 10, comprising a body 20, grip members 30 fixedly attached to said body 20, and fastening means 40 to connect said tire traction enhancing device 10 to a standard vehicle tire 50. Preferably, said body 20 of said tire traction enhancing device 10 is rectangular, of width equivalent to or slightly smaller than the width of said vehicle tire tread area 50, and of sufficient length to cover ⅔ of the circumference of said vehicle tire 50 tread surface. Preferably, said body 20 is made from ⅛″ thick known polyester fabric impregnated with PVC on both sides, rendering said body 20 impervious to moisture and rot, and resistant to ripping, tearing or gouging. Preferably, a plurality of said grip members 30, preferably of generally U-shaped steel, preferably 4 inches long, 3/4 inch wide and 3/8 inch high are fixably attached to said body 20, preferably with fastening means 40. Preferably, said fastening means 40 comprises pan head bolts 60 as shown in FIG. 2 and 3/16″ flat washers 70 are fixably attached to said pan head bolts 60 on a bottom surface of said body 20. Preferably, said pan head bolts 60 are of a width and length which enables insertion thereof into the tread space or groove of said tire 50 as shown in FIG. 6, and are thereby gripped by said tire's tread spaces but do not puncture said tire. For an ordinary vehicle, a preferred dimension of said pan head bolts 60 would be 3/16″×⅝″.

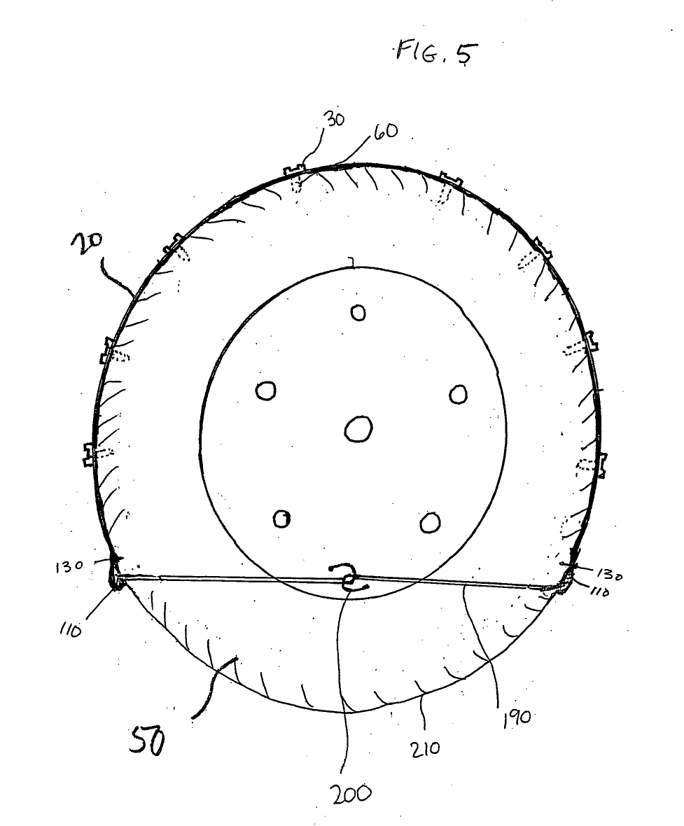

As shown in FIG. 4, said grip members 30 are preferably arranged in a manner such that each of said grip members 30 is oriented at 90 degrees to the next nearest of said grip members 30 and at substantially forty-five degrees to a lengthwise edge 80 of said body 20, in a known “tractor tire” tread pattern. This is a preferred pattern to reduce side slippage of the vehicle during operation of the device. In a preferred embodiment for an average car tire, there are sixteen of said grip members 30, but the number would vary depending on the size of said body 20 which would vary in proportion to the size of said tire 50.

In the preferred embodiment, at each end 90 of said body 20 are two rows of drilled or punched holes 100, preferably 3/16″ wide.

As shown in FIG. 2, a channel 110 of said body 20 is created at each end 90 as shown in FIG. 1 of said body 20 by folding the edge 120 as shown in FIG. 2 under itself through 180 degrees such that said holes 100 as shown in FIG. 3 align. As shown in FIG. 3, preferably, ordinary bolts 130, preferably of dimensions 3/16″×⅝″ are inserted into holes 100 and fixed preferably using 3/16″ flat washers 140 on both top surface 150 and bottom surface 160 of said body 20 and preferably a 3/16″ lock washer 170 and nut 180 on the bottom surface 160 of said body 20.

As shown in FIG. 2, preferably, a length of bungee type cord 190, preferably of a length which, when pulled tense, is sufficient to encircle diametrically said vehicle tire 50, is threaded through both of said channels 110 of said body 20. If said bungee type cord 190 is too long, the device is less likely to remain positioned securely about the tire. A standard hook member 210 is attached to each end of said bungee type cord 200.

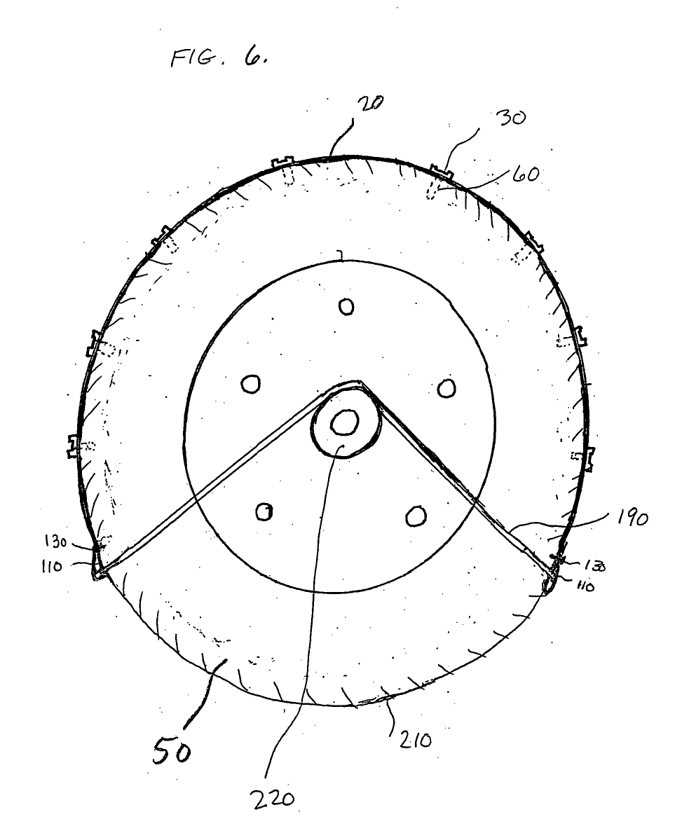

As shown in FIG. 5, in use, said body 20 is placed over the tread surface 210 of a vehicle tire 50 such that said pan head bolts 60 of said grip members 30 contact or protrude into said tread surface 210, a majority of said pan head bolts 60 inserting into spaces in said tread surface 210 thereby attaching and stabilizing said body 20 to said vehicle tire 50. The user then pushes the said bungee type cord 200 down about the inner surface (sidewall) of said tire such that said bungee type cord 190 rests on the vehicle axle 220, as shown in FIG. 6, and then clips said hooks 210 together at the outer surface (sidewall) of said tire, as shown in FIG. 5, to form a tensioned closed loop that holds said tire traction enhancing device 10 in place about said vehicle tire 50. The vehicle may then be moved slowly forward or backward, said device enhancing the traction of said vehicle tire 50 to provide the vehicle with sufficient traction to escape from being stuck in mud or snow. The above description is intended to be illustrative rather than construed in a restrictive sense, and variations to the specific configurations described may be apparent to skilled persons in adapting the present invention to specific applications. Such variations are intended to form part of the present invention insofar as they are within the spirit and scope of the claims below.

1. A tire traction enhancing device comprising:
a flexible body member; gripping means, protruding from said flexible body member, for gripping ground material; and releasable attachment means flexibly tensionably connecting a first end of said flexible body member to a second end of said flexible body member about a standard vehicle tire.

2. The tire traction enhancing device of claim 1 wherein said means for gripping ground material comprises a plurality of grip members fixedly attached to said body member.

3. The tire traction enhancing device of claim 2 wherein said grip members are U-shaped.

4. The tire traction enhancing device of claim 2 wherein each of said grip members is fixedly attached to an upper surface of said body member with fastening means comprising standard bolts, said bolts being of sufficient length to traverse through each of said grip members, through said body member, and protrude outwardly from a lower surface of said body member said bolts being of sufficient diameter to enable releasable engagement of said bolts with a standard vehicle tire tread space.

5. The tire traction enhancing device of claim 3 wherein each of said grip members is fixedly attached to an upper surface of said body member with fastening means comprising standard bolts, said bolts being of sufficient length to traverse through each of said grip members, through said body member, and protrude outwardly from a lower surface of said body member said bolts being of sufficient diameter to enable releasable engagement of said bolts with a standard vehicle tire tread space.

6. The tire traction enhancing device of claim 5 wherein said fastening means further comprises a first standard washer placed about each of said bolts at said upper surface of said body member and a second standard washer about each of said bolts at said lower surface of said body member, and a standard nut about each of said bolts below said standard second washer.

7. The tire traction enhancing device of claim 6 wherein said grip members are arranged such that each of said grip members is oriented substantially perpendicular relative to the next grip member and at substantially forty-five degrees to a lengthwise edge of said body member in a known “tractor tread” pattern.

8. The tire traction enhancing device of claim 7 wherein said releasable attachment means comprises a standard bungee type cord having a standard hook means at a first and second end thereof.

9. The tire traction enhancing device of claim 8 wherein said body member further comprises a first hollow channel at a first end thereof and a second hollow channel at a second end thereof, said first hollow channel being created by folding a first end of said body member under itself through one hundred eighty degrees and fixedly attaching said first end to said body member, using known attachment means, said second hollow channel being created by folding a second end of said body member under itself through one hundred eighty degrees and fixedly attaching said second end to said body member using known attachment means.

10. The tire traction enhancing device of claim 9 wherein said body member is adapted to provide a plurality of holes arranged in two parallel rows at each of said first and second ends of said body member, said two parallel rows being aligned at each of said first and second ends when each of said ends is folded under itself through one hundred eighty degrees and wherein said known attachment means comprises a standard bolt inserted through each of said aligned holes and affixed with a standard washer, locking washer and nut.

11. The tire traction enhancing device of claim 10 wherein said releasable attachment means is threaded through said first hollow channel and said second hollow channel.

12. The tire traction enhancing device of claim 11 wherein said body member is of known polyester fabric coated with polyvinyl chloride (PVC).

13. The tire traction enhancing device of claim 12 wherein said body member is substantially rectangular and of a width equivalent to or slightly smaller than the width of a vehicle tire and of a length equivalent to substantially two thirds of the circumference of a vehicle tire.

14. The tire traction enhancing device of claim 13 wherein said bungee type cord is of a sufficient length, when taut, to encircle a vehicle tire diametrically.

15. A tire traction enhancing device comprising:
an elongate, strip form, flexible body member having a first longitudinal end and a second longitudinal end, opposite said first longitudinal end and, a first major face and a second major face, opposite said first major face;
gripping means for gripping ground material protruding from the first major face of the body member;
releasable anchoring means for anchoring the tire traction device to a tread of a tire protruding from the second major face of the body member and being receivable as press fits in grooves of the tire tread so as to be releasably gripped thereby; and,
releasable attachment means for attaching said first longitudinal end of said flexible body member and said second longitudinal end of said flexible body member to a standard vehicle tire with the flexible body member wrapped around a circumferential periphery thereof and with the releasable anchoring means press fitted in grooves of the tire tread.

16. The tire traction enhancing device of claim 15, wherein the releasable anchoring means comprise studs fixed to the gripping means adjacent the body member.

17. The tire traction enhancing device of claim 16, wherein the releasable attachment means attaches said first longitudinal end of said flexible body member and said second longitudinal end of said flexible body member to a standard vehicle tire by tying the first and second longitudinal ends together about a tire.

18. The tire traction enhancing device of claim 17 wherein said gripping means comprises a plurality of grip member portions of channel section fixedly attached to the body member with respective free edges of respective channel walls remote from the body member and with the studs fixed to respective channel bases and traversing through the body member.

19. The tire traction enhancing device of claim 18 wherein each of said grip member portions is fixedly attached to an upper surface of said body member with fastening means comprising standard bolts, said studs being formed by shanks of said bolts.
